(19) United States
(12) Patent Application Publication
(10) Pub. No.: US 2021/0133145 A1
(43) Pub. Date: May 6, 2021

(54) METHOD, ELECTRONIC DEVICE AND COMPUTER PROGRAM PRODUCT FOR MANAGING FILE SYSTEM

(71) Applicant: EMC IP Holding Company LLC, Hopkinton, MA (US)

(72) Inventors: Min Gong, Shanghai (CN); Xin Wu, Shanghai (CN); Meng Wang, Shanghai (CN); Minglong Sun, Shanghai (CN)

(21) Appl. No.: 16/833,287

(22) Filed: Mar. 27, 2020

(30) Foreign Application Priority Data
Nov. 1, 2019 (CN) 201911059016.9

(51) Int. Cl. G06F 16/11; G06N 20/00

(52) U.S. Cl. CPC G06F 16/122; G06N 20/00

(57) ABSTRACT

There is provided method, electronic device and computer program product for managing a file system. The method for managing a file system comprises determining a target file folder with an access frequency exceeding a frequency threshold in the file system; determining, based on an attribute of the target file folder, a cause associated with access to the target file folder; and determining, based on the cause, a strategy associated with the access to the target file folder, to improve access efficiency of the file system.

### RELATED APPLICATION

The present application claims the benefit of priority to Chinese Patent Application No. 201911059016.9, filed on Nov. 1, 2019, which application is hereby incorporated into the present application by reference herein in its entirety.

### FIELD

Embodiments of the present disclosure generally relate to the field of file systems, and more specifically, to a method, electronic device and computer program product for managing a file system.

### BACKGROUND

The file system is the foundation of modern information technology. In the file system, typical file hierarchy tends to place files in corresponding file folders according to workflows of the files (e.g., projects, ownerships and the like). Usually, the users need to analyze the working condition of the file system to make a further file system management decision, which calls for a solution which can analyze the file system in-depth and manage the file system based on the result of the analysis.

### SUMMARY

Embodiments of the present disclosure provide an improved solution for managing a file system.

In accordance with a first aspect of the present disclosure, a method for managing a file system is proposed. The method comprises: determining a target file folder with an access frequency exceeding a frequency threshold in the file system; determining, based on an attribute of the target file folder, a cause associated with access to the target file folder; and determining, based on the cause, a strategy associated with the access to the target file folder, to improve access efficiency of the file system.

In accordance with a second aspect of the present disclosure, an electronic device for managing a file system is proposed. The device comprises at least one processing unit and at least one memory coupled to the at least one processing unit and storing instructions executed by the at least one processing unit. The instructions, when executed by the at least one processing unit, cause the device to perform acts including: determining a target file folder with an access frequency exceeding a frequency threshold in the file system; determining, based on an attribute of the target file folder, a cause associated with access to the target file folder; and determining, based on the cause, a strategy associated with the access to the target file folder, to improve access efficiency of the file system.

In accordance with a third aspect of the present disclosure, a computer program product is proposed. The computer program product is tangibly stored on a non-transitory computer-readable medium and including machine-executable instructions, the machine-executable instructions, when executed, causing a machine to perform steps of the method according to the first aspect of the present disclosure.

This Summary is provided to introduce a selection of concepts in a simplified form that are further described below in the Detailed Description. This Summary is not intended to identify key features or essential features of the present disclosure, nor is it intended to be used to limit the scope of the present disclosure.

### BRIEF DESCRIPTION OF THE DRAWINGS

Through the following more detailed description of the example embodiments of the present disclosure with reference to the accompanying drawings, the above and other objectives, features, and advantages of the present disclosure will become more apparent, wherein the same reference number usually refers to the same component in the example embodiments of the present disclosure.

FIG. 1 illustrates a schematic diagram of an example of a file system management environment in which some embodiments of the present disclosure can be implemented;

FIG. 2 illustrates a flowchart of a method for managing the file system in accordance with some embodiments of the present disclosure;

FIG. 3 illustrates a schematic diagram of an example for determining the target file folder in accordance with some embodiments of the present disclosure;

FIG. 4 illustrates a schematic diagram of an example for determining the cause associated with the access to the target file folder in accordance with some embodiments of the present disclosure;

FIG. 5 illustrates a schematic diagram of a further example for determining the cause associated with the access to the target file folder in accordance with some embodiments of the present disclosure; and

FIG. 6 illustrates a schematic block diagram of an example device for implementing embodiments of the present disclosure.

In each drawing, same or corresponding numbers represent same or corresponding parts.

### DETAILED DESCRIPTION OF EMBODIMENTS

Embodiments of the present disclosure will be described in more detail below with reference to the drawings. Although the drawings illustrate the embodiments of the present disclosure, it should be appreciated that the present disclosure can be implemented in various manners and should not be limited to the embodiments set forth herein. On the contrary, the embodiments are provided to make the present disclosure more thorough and complete and to fully convey the scope of the present disclosure to those skilled in the art.

As used herein, the term “includes” and its variants are to be read as open-ended terms that mean “includes, but is not limited to.” The term “or” is to be read as “and/or” unless the context clearly indicates otherwise. The term “based on” is to be read as “based at least in part on.” The terms “one example embodiment” and “one embodiment” are to be read as “at least one example embodiment.” The term “a further embodiment” is to be read as “at least a further embodiment.” The terms “first”, “second” and so on can refer to same or different objects unless indicated otherwise.

Workload monitoring of a storage system is critical for its users. The users deserve to know how their storage spaces are used and how they perform, which is the basis for making their further storage management decisions. An example of the workload monitoring in the storage system is access hotspot detection, e.g., detecting elements (e.g., storage blocks, users and protocols etc.) which consume large amounts of Input/Output (I/O) resources.

In the file system, typical file hierarchy tends to place files in corresponding file folders according to workflows of the files (e.g., projects, ownerships and the like). In such case, the users are more interested in files and file folders than storage blocks. Therefore, the key to workload monitoring for unstructured data storage in the file system is determining a critical file folder frequently accessed in the storage system. In this text, because the file folder can be identified by a path from a root directory to the file folder, the determination of the file folder is equivalent to determining the path from the root directory to the file folder.

The determination of critical file folders is of great importance for the management of the file system because the critical file folders not only consume massive I/O resources, but also have the potential to be the bottleneck for the performance of the file system. However, traditionally, there are no existing products or tools capable of assisting the users in analyzing causes for the frequent access to the critical file folders or providing file system management strategies for frequent access with different causes.

In accordance with example embodiments of the present disclosure, an improved solution of managing file systems is proposed. In this solution, a target file folder with an access frequency exceeding a frequency threshold in the file system is determined. Based on an attribute of the target file folder, a cause associated with access to the target file folder is determined. A strategy associated with the access to the target file folder is determined based on the cause, to improve access efficiency of the file system.

In this way, the cause for the frequent access to the target file folder may be determined automatically and accurately by monitoring the attribute of the target file folder. Furthermore, the file system management strategy directed at the determined cause can also be performed. Accordingly, the performance of the file system may be improved flexibly, intelligently and effectively.

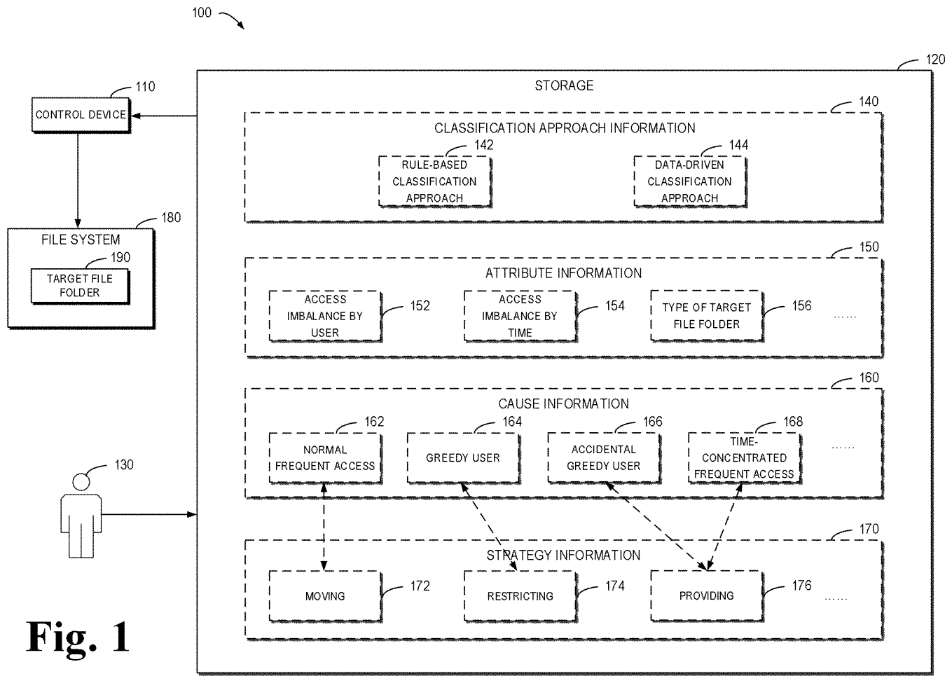

Specific examples of the present solution are described in details below with reference to FIGS. 1-6. FIG. 1 illustrates a schematic diagram of an example of a file system management environment 100 in which some embodiments of the present disclosure can be implemented. The file system management environment 100 includes a control device 110, a storage 120, a user 130 and a file system 180.

As shown in FIG. 1, the control device 110 and the storage 120 are implemented outside the file system 180. Alternatively, the control device 110 and the storage 120 can be implemented within the file system 180 and their implementation locations are not limited. The control device 110 may include, but are not limited to, any devices with computing capability, such as a cloud computing device, mainframe computer, server, personal computer, desktop computer, laptop computer, tablet and personal digital assistant etc. The storage 120 may include any devices with storage capability like magnetic storage media and optical storage media.

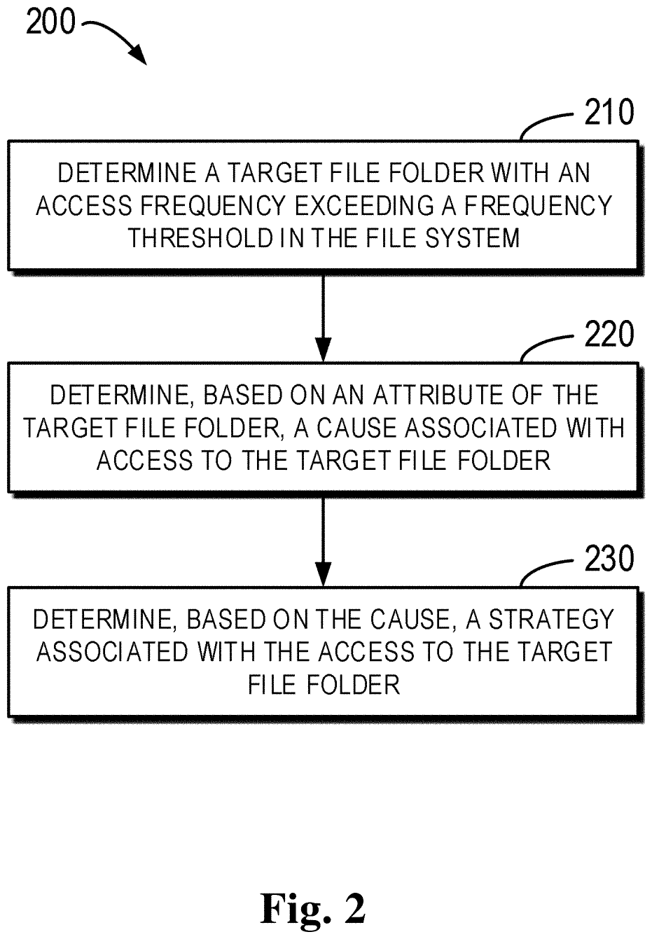

The control device 110 may manage the file system 180. In brief, the control device 110 may determine a target file folder 190 with an access frequency exceeding the frequency threshold in the file system 180. Besides, the control device 110 may determine, based on the attribute of the target file folder 190, a cause associated with the access to the target file folder 190. Furthermore, the control device 110 may determine, based on the cause, a strategy associated with the access to the target file folder 190. Operations of the control device 110 are described in details below with reference to FIGS. 2 to 5.

While managing the storage system 180, the control device 110 may access the storage 120, which may store configuration information supporting the management of the file system 180. The configuration information may be predetermined by the users 130. Alternatively, the configuration information also may be default or determined according to the actual operating condition of the file system 180. The configuration information is extensible. The user 130 may extend the configuration information on demand Alternatively, the configuration information also may be extended according to the actual operating condition of the file system 180.

As an example, the configuration information may include classification approach information 140, attribute information 150, cause information 160 and strategy information 170. For example, the classification approach information 140 may indicate how the target file folder 190 is classified to determine the cause associated with the access to the target file folder 190. The classification approach information 140 may indicate rule-based classification approach 142 and data-driven classification approach 144.

The attribute information 150 may indicate attributes used to determine the cause. For example, the attribute information 150 may indicate access imbalance by user 152, access imbalance by time 154 and type of the target file folder 156 etc. The access imbalance by user 152 may indicate a standard deviation of access rates of the target file folder 190 by a plurality of users accessing the target file folder 190. For example, if the access rates of the target file folder 190 for three users are 10%, 10% and 80%, respectively, the access imbalance by user 152 is 0.404.

The access imbalance by time 154 may indicate a standard deviation of access rates of the target file folder 190 during each of a plurality of time periods. For example, if the access rates of the target file folder 190 in each hour from 1 o'clock to 6 o'clock are 10%, 10%, 10%, 10% and 60%, respectively, the access imbalance by time 154 is 0.224.

The type of the target file folder 156 may indicate whether the target file folder 190 is a public target file folder or a private target file folder. For example, if the target file folder 190 is owned by a team user, the type of the target file folder 156 is public. However, if the target file folder 190 is owned by an individual user, the type of the target file folder 156 is private.

The cause information 160 may indicate the cause associated with the access to the target file folder 190. For example, the cause information 160 may indicate normal frequent access 162, greedy user 164, accidental greedy user 166 and time-concentrated frequent access 168.

The strategy information 170 may indicate a strategy associated with the access to the target file folder. The strategy may be used for improving the access efficiency of the file system 180. For example, the strategy may include moving 172 the target file folder 190 from a source storage storing the target file folder 190 to a destination storage. An access speed to the destination storage exceeds a speed threshold. The strategy also may include restricting 174 the access to the target file folder 190 by the user. In addition, the strategy may further include providing the cause to the user 130.

The strategy and the cause may have a predetermined correspondence, such that the strategy can be determined based on the cause. For example, the normal frequent access 162 may correspond to the moving 172, and the greedy user 164 may correspond to the restricting 174. In some embodiments, different causes may correspond to the same strategy. For example, both the occasional greedy user 166 and the time-concentrated frequent access 168 may correspond to the providing 176.

In this way, the control device 110 may determine, based on the attribute of the target file folder 190, the cause for frequent access to the target file folder 190 according to an indication of the configuration information, and further determine the file system management strategy based on the determined causes. Therefore, the access efficiency of the file system can be improved flexibly, intelligently and effectively.

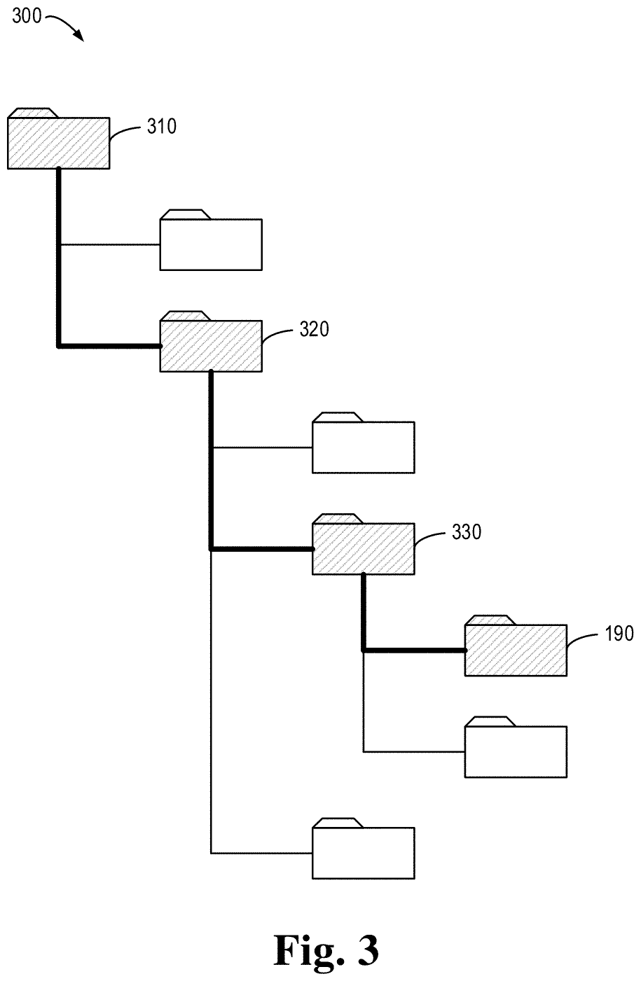

Operations of the control device 110 are described in detail below with reference to FIGS. 2-5. FIG. 2 illustrates a flowchart of a method 200 for managing the file system in accordance with some embodiments of the present disclosure. For example, the method 200 may be performed by the control device 110 shown in FIG. 1. It should be appreciated that the method 200 may also include additional steps not shown and/or omit the steps shown. The scope of the present disclosure is not restricted in this regard. To facilitate understanding, the method 200 will be described with reference to FIGS. 3-5.

At 210, the control device 110 determines the target file folder 190 with an access frequency exceeding the frequency threshold in the file system 180. For example, the control device 110 may determine a file folder which is frequently accessed at a rate over 100 times per second as the target file folder 190. In another example, the control device 110 may determine the file folder with the highest access frequency as the target file folder 190.

As described above, since the file can be identified by the path from the root directory to the file folder, determining the file folder means determining the path from the root directory to the file folder. In view of this, determining the target file folder 190 means determining the path of the target file folder 190. To facilitate understanding, the determination of the target file folder is described with reference to FIG. 3, which illustrates a schematic diagram 300 of an example for determining the target file folder in accordance with some embodiments of the present disclosure. As shown in FIG. 3, the path of the target file folder 190 is “/file folder 310/file folder 320/file folder 330/file folder 190.”

In some embodiments, the control device 110 may directly determine the target file folder 190 with an access frequency exceeding the frequency threshold, for example, through a predetermined command. Alternatively, the control device 110 may determine the target file folder 190, for example, through a further predetermined command in a hierarchical way. For example, the control device 110 may determine a file folder with the highest access frequency in the file folders of the same tier, and further determine a sub-file folder with the highest access frequency in the sub-file folders of the file folder. The procedure is performed iteratively until the predetermined condition is met.

The predetermined condition may be default, or preset by the user 130, or determined according to the actual operating condition of the file system 180. For example, the predetermined condition may be reaching the file folder at the lowest tier. The file folder at the lowest tier is a file folder that has no sub-file folders. The predetermined condition may also be a tier number of the file folder, for example, the file folder is positioned 3 tiers down from the root directory (considered as tier 0).

As shown in FIG. 3, the control device 110 may determine that the file folder with the highest access frequency at the tier 0 is the file folder 310. The sub-file folder with the highest access frequency in the sub-file folders of the file folder 310 at tier 1 is the file folder 320; the sub-file folder with the highest access frequency in the sub-file folders of the file folder 320 at tier 2 is the file folder 330; and the sub-file folder with the highest access frequency in the sub-file folders of the file folder 330 at tier 3 is the file folder 190. As the file folder 190 is positioned at the lowest tier or 3 tiers down from the file folder 310 acting as the root directory, the control device 110 may determine the file folder 190 as the target file folder.

At 220, the control device 110 determines, based on the attribute of the target file folder 190, the cause associated with the access to the target file folder 190. The control device 110 may classify the target file folder 190 based on its attribute using various classification approaches, so as to determine the cause associated with the access to the target file folder 190.

As described above, the classification approach may include a rule-based classification approach 142 and data-driven classification approach 144. In some embodiments, the control device 110 may obtain the classification approach information 140 from the storage 120, determine the classification method indicated by the classification approach information 140 and classify the target file folder 190 according to the classification method, thereby determining the cause associated with the access to the target file folder 190.

Specifically, when the classification approach information 140 indicates the rule-based classification approach 142, the control device 110 may obtain the attribute information 150 from the storage 120, and determine the attribute indicated by the attribute information 150. Afterwards, the control device 110 may determine a value of the attribute, compare the attribute value with an attribute threshold, and then determine the cause associated with the access to the target file folder 190 based on the comparison result.

For example, the control device 110 may determine, from the obtained attribute information 150, the cause is to be determined based on the access imbalance by user 152. Therefore, the control device 110 may determine the value of the access imbalance by user 152 and compare the value with an attribute threshold for the access imbalance by user 152. For example, if the value of access imbalance by user 152 is below the attribute threshold, it means that the access to the file target folder 190 by the users is balanced and the cause for the frequent access to the target file folder 190 is determined as the normal frequent access 162. On the contrary, if the value of access imbalance by user 152 exceeds the attribute threshold, it means that the access to the target file folder 190 by the users is imbalanced. Hence, the cause for frequent access to the target file folder 190 may probably be some users accessing the target file folder 190 too frequently. Accordingly, the cause for frequent access to the target file folder 190 may be determined as the greedy user 164.

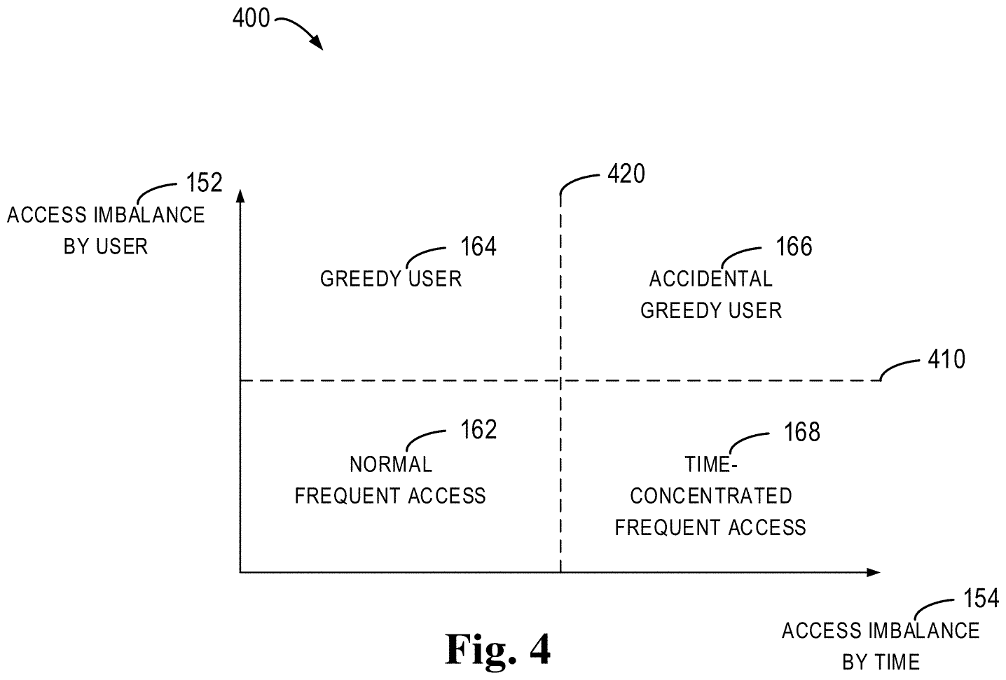

Furthermore, the control device 110 may comprehensively consider a plurality of attributes to more accurately determine the cause associated with the access to the target file folder 190. FIG. 4 illustrates a schematic diagram 400 of an example for determining the cause associated with the access to the target file folder 190 in accordance with some embodiments of the present disclosure.

For example, when the cause is determined based on the access imbalance by user 152 and the access imbalance by time 154, the control device 110 may determine the value of the access imbalance by user 152 and the value of the access imbalance by time 154. The control device 110 may compare the values of the two attributes with attribute thresholds 410 and 420 respectively to determine the cause associated with the access to the target file folder 190.

As shown in FIG. 4, when the value of the access imbalance by user 152 exceeds the attribute threshold 410 and the value of the access imbalance by time 154 is below the attribute threshold 420, it means that the access to the target file folder 190 by the users is imbalanced while the access to the target file folder 190 in each time period is balanced. Therefore, the cause for the frequent access to the target file folder 190 may probably be some users accessing the target file folder 190 in a continuous and frequent way and accordingly may be determined as the greedy user 164.

If the value of the access imbalance by user 152 exceeds the attribute threshold 410 and the value of the access imbalance by time 154 also exceeds the attribute threshold 420, it means that the access to the target file folder 190 by the users is imbalanced, and the access to the target file folder 190 in each time period is also imbalanced. Therefore, the cause for the frequent access to the target file folder 190 may probably be some users accessing the target file folder 190 in an accidental and frequent way and accordingly may be determined as the accidental greedy user 166.

When the value of the access imbalance by user 152 is below the attribute threshold 410 and the value of the access imbalance by time 154 is also below the attribute threshold 420, it means that the access to the target file folder 190 by the users is balanced, and the access to the target file folder 190 in each time period is also balanced. Therefore, the cause for the frequent access to the target file folder 190 may be determined as the normal frequent access 162.

If the value of the access imbalance by user 152 is below the attribute threshold 410 and the value of the access imbalance by time 154 exceeds the attribute threshold 420, it means that the access to the target file folder 190 by the users is balanced while the access to the target file folder 190 in each time period is imbalanced. In this case, no users have accessed the target file folder 190 too frequently, so the cause for the frequent access to the target file folder 190 is determined as the time-concentrated frequent access 168.

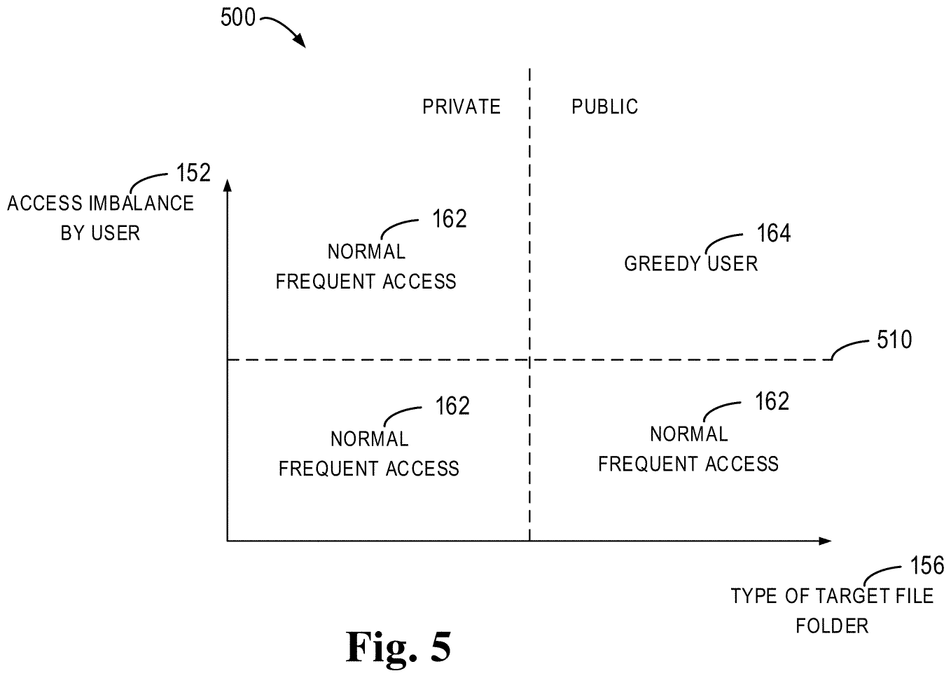

FIG. 5 illustrates a schematic diagram 500 of a further example for determining the cause associated with the access to the target file folder in accordance with some embodiments of the present disclosure. For example, when the cause is determined based on the access imbalance by user 152 and the type of the target file 156, the control device 110 may determine the value of the access imbalance by user 152 and the value of the type of the target file 156. The control device 110 may compare the value of the access imbalance by user 152 with an attribute threshold 510 and determine whether the value of the type of the target file 156 is public or private, so as to determine the cause associated with the access to the target file folder 190.

As shown in FIG. 5, if the value of the access imbalance by user 152 is below the attribute threshold 510, it means that the access to the target file folder 190 by the users is balanced. Accordingly, no matter the value of the type of the target file 156 indicates public or private, the access to the target file folder 190 is considered as reasonable. Hence, the cause for the frequent access to the target file folder 190 is determined as normal frequent access 162.

In addition, if the value of the type of the target file 156 indicates private, it means that the target file folder 190 belongs to a specific user and the frequent access to the target file folder 190 by the specific user is reasonable. In such case, even if the value of the access imbalance by user 152 exceeds the attribute threshold 510, the cause for the frequent access to the target file folder 190 may also be determined as the normal frequent access 162.

Moreover, when the value of the type of the target file 156 indicates public and the value of the access imbalance by user 152 exceeds the attribute threshold 510, it means that the access to the shared target file folder 190 by users is imbalanced. Accordingly, the cause for the frequent access to the target file folder 190 may probably be some users access the target file folder 190 too frequently and accordingly may be determined as the greedy user 164.

The above text describes how the cause associated with the access to the target file folder 190 is determined by the rule-based classification approach 142. However, in addition to the rule-based classification approach 142, the cause associated with the access to the target file folder 190 also may be determined by the data-driven classification approach 144, which is suitable for the scenarios when users fail to provide detailed rules for cause classification.

Before the target file folder 190 is classified with the data-driven classification approach 144 to determine the cause, it is required to train a classifier in advance. During the training phase, the control device 110 may obtain historical attribute values and historical types of the attributes of a plurality of training file folders, and train the classifier based on the historical attribute values and the historical types. In this way, the classifier is trained based on the historical data using a supervised learning method (e.g., any suitable machine learning methods like decision tree, support vector machine, random forest and neural network etc.), such that the trained classifier may predict possible causes through the input attribute values.

During the application phase, the control device 110 may obtain, from the storage 120, the attribute information 150 of the target file folder 190, determine the attribute indicated by the attribute information 150 and determine a value of the attribute. Then, the control device 110 may apply the attribute value to the trained classifier, to determine the cause associated with the access to the target file folder 190. Determination of the attribute and its value as well as the cause have been described in details above and will be omitted here.

Referring back to FIG. 2, at 230, the control device 110 determines, based on the determined causes, a strategy associated with the access to the target file folder 190 to improve the access efficiency of the file system 180. In some embodiments, the control device 110 may obtain, from the storage 120, the strategy information 170, and determine a set of candidate strategies for the target file folder 190 based on the strategy information 170. Moreover, the control device 110 also may obtain, from the storage 120, the cause corresponding to each candidate strategy. Therefore, the control device 110 may determine a candidate strategy which corresponds to a cause matching the cause for the target file folder 190 as a strategy to be performed for improving the access efficiency of the file system 180.

For example, when the cause is determined to be the normal frequent access 162, the control device 110 may determine that the strategy is moving the target file folder 190 from a source storage storing the target file folder 190 to a destination storage. An access speed to the destination storage exceeds a speed threshold. When the cause is determined to be the greedy user 164, the control device 110 may determine that the strategy is restricting the access to the target file user 190 by users. Besides, when the cause is determined to be the accidental greedy user 166 and time-concentrated frequent access 168, the control device 110 may determine that the strategy is providing the determined cause to the user.

In this way, the cause for the frequent access to the target file folder is automatically and accurately determined by monitoring the attributes of the target file folder. Moreover, the strategy directed to the determined cause may be performed, so as to flexibly, intelligently and effectively improve the performance of the file system.

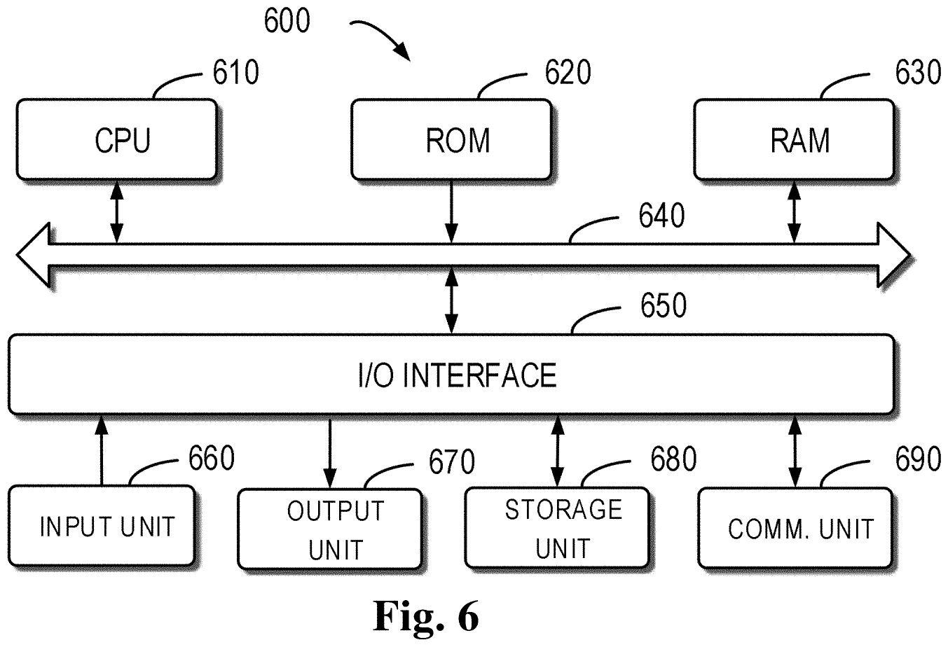

FIG. 6 illustrates a schematic block diagram of an example device 600 for implementing embodiments of the present disclosure. For example, the control device 110 shown by FIG. 1 may be implemented by the device 600. As shown, the device 600 includes a central processing unit (CPU) 610, which can execute various suitable actions and processing based on the computer program instructions stored in the read-only memory (ROM) 620 or computer program instructions loaded in the random-access memory (RAM) 630 from a storage unit 680. The RAM 630 can also store all kinds of programs and data required by the operations of the device 600. CPU 610, ROM 620 and RAM 630 are connected to each other via a bus 640. The input/output (I/O) interface 650 is also connected to the bus 640.

A plurality of components in the device 600 is connected to the I/O interface 650, including: an input unit 660, such as a keyboard, mouse and the like; an output unit 670, e.g., various kinds of display and loudspeakers etc.; a storage unit 680, such as magnetic disk and optical disk etc.; and a communication unit 690, such as network card, modem, wireless transceiver and the like. The communication unit 690 allows the device 600 to exchange information/data with other devices via the computer network, such as Internet, and/or various telecommunication networks.

The above described procedures and processings, such as method 200, can also be executed by the processing unit 610. For example, in some embodiments, the method 200 can be implemented as a computer software program tangibly included in the machine-readable medium, e.g., storage unit 680. In some embodiments, the computer program can be partially or fully loaded and/or mounted to the device 600 via ROM 620 and/or communication unit 690. When the computer program is loaded to RAM 630 and executed by the CPU 610, one or more acts of the above described method 200 can be implemented.

The present disclosure can be method, apparatus, system/or computer program product. The computer program product can include a computer-readable storage medium, on which the computer-readable program instructions for executing various aspects of the present disclosure are loaded.

The computer-readable storage medium can be a tangible apparatus that maintains and stores instructions utilized by the instruction executing apparatuses. The computer-readable storage medium can be, but is not limited to, an electrical storage device, magnetic storage device, optical storage device, electromagnetic storage device, semiconductor storage device or any appropriate combinations of the above. More concrete examples of the computer-readable storage medium (non-exhaustive list) include: portable computer disk, hard disk, random-access memory (RAM), read-only memory (ROM), erasable programmable read-only memory (EPROM or flash), static random-access memory (SRAM), portable compact disk read-only memory (CD-ROM), digital versatile disk (DVD), memory stick, floppy disk, mechanical coding devices, punched card stored with instructions thereon, or a projection in a slot, and any appropriate combinations of the above. The computer-readable storage medium utilized here is not interpreted as transient signals per se, such as radio waves or freely propagated electromagnetic waves, electromagnetic waves propagated via waveguide or other transmission media (such as optical pulses via fiber-optic cables), or electric signals propagated via electric wires.

The described computer-readable program instructions can be downloaded from the computer-readable storage medium to each computing/processing device, or to an external computer or external storage via Internet, local area network, wide area network and/or wireless network. The network can include copper-transmitted cable, optical fiber transmission, wireless transmission, router, firewall, switch, network gate computer and/or edge server. The network adapter card or network interface in each computing/processing device receives computer-readable program instructions from the network and forwards the computer-readable program instructions for storage in the computer-readable storage medium of each computing/processing device.

The computer program instructions for executing operations of the present disclosure can be assembly instructions, instructions of instruction set architecture (ISA), machine instructions, machine-related instructions, microcodes, firmware instructions, state setting data, or source codes or target codes written in any combination of one or more programming languages, wherein the programming languages consist of object-oriented programming languages, e.g., Smalltalk, C++ and so on, and traditional procedural programming languages, such as “C” language or similar programming languages. The computer-readable program instructions can be implemented fully on the user computer, partially on the user computer, as an independent software package, partially on the user computer and partially on the remote computer, or completely on the remote computer or server. In the case where a remote computer is involved, the remote computer can be connected to the user computer via any type of network, including local area network (LAN) and wide area network (WAN), or to an external computer (e.g., connected via Internet using the Internet service provider). In some embodiments, state information of the computer-readable program instructions is used to customize an electronic circuit, e.g., programmable logic circuit, field programmable gate array (FPGA) or programmable logic array (PLA). The electronic circuit can execute computer-readable program instructions to implement various aspects of the present disclosure.

Various aspects of the present disclosure are described here with reference to flow chart and/or block diagram of method, apparatus (system) and computer program products according to embodiments of the present disclosure. It should be understood that each block of the flow chart and/or block diagram and the combination of various blocks in the flow chart and/or block diagram can be implemented by computer-readable program instructions.

The computer-readable program instructions can be provided to the processing unit of a general-purpose computer, dedicated computer or other programmable data processing apparatuses to manufacture a machine, such that the instructions, when executed by the processing unit of the computer or other programmable data processing apparatuses, generate an apparatus for implementing functions/actions stipulated in one or more blocks in the flow chart and/or block diagram. The computer-readable program instructions can also be stored in the computer-readable storage medium and cause the computer, programmable data processing apparatus and/or other devices to work in a particular manner, such that the computer-readable medium stored with instructions contains an article of manufacture, including instructions for implementing various aspects of the functions/actions stipulated in one or more blocks of the flow chart and/or block diagram.

The computer-readable program instructions can also be loaded into computer, other programmable data processing apparatuses or other devices, so as to execute a series of operation steps on the computer, other programmable data processing apparatuses or other devices to generate a computer-implemented procedure. Therefore, the instructions executed on the computer, other programmable data processing apparatuses or other devices implement functions/actions stipulated in one or more blocks of the flow chart and/or block diagram.

The flow chart and block diagram in the drawings illustrate system architecture, functions and operations that may be implemented by system, method and computer program product according to multiple implementations of the present disclosure. In this regard, each block in the flow chart or block diagram can represent a module, a part of program segment or code, wherein the module and the part of program segment or code include one or more executable instructions for performing stipulated logic functions. In some alternative implementations, it should be noted that the functions indicated in the block can also take place in an order different from the one indicated in the drawings. For example, two successive blocks can be in fact executed in parallel or sometimes in a reverse order dependent on the involved functions. It should also be noted that each block in the block diagram and/or flow chart and combinations of the blocks in the block diagram and/or flow chart can be implemented by a hardware-based system exclusive for executing stipulated functions or actions, or by a combination of dedicated hardware and computer instructions.

Various implementations of the present disclosure have been described above and the above description is only exemplary rather than exhaustive and is not limited to the implementations of the present disclosure. Many modifications and alterations, without deviating from the scope and spirit of the explained various implementations, are obvious for those skilled in the art. The selection of terms in the text aims to best explain principles and actual applications of each implementation and technical improvements made in the market by each embodiment, or enable others of ordinary skill in the art to understand implementations of the present disclosure.

I/We claim:

1. A method, comprising:
determining, by a system comprising a processor, a target file folder with an access frequency exceeding a frequency threshold in a file system being managed by the system;
determining, based on an attribute of the target file folder, a cause associated with access to the target file folder; and
determining, based on the cause, a strategy associated with the access to the target file folder, to improve access efficiency of the file system.

2. The method of claim 1, wherein the determining the target file folder comprises:
determining, from file folders in the file system, a sub-file folder with an access frequency exceeding the frequency threshold; and
determining the sub-file folder as the target file folder.

3. The method of claim 1, wherein the determining the cause comprises:
determining the attribute;
determining an attribute value of the attribute; and
applying the attribute value to a classifier that has been trained to determine the cause.

4. The method of claim 3, further comprising:
obtaining historical attribute values and historical types of the attributes of a plurality of training file folders; and
training the classifier based on the historical attribute values and the historical types.

5. The method of claim 1, wherein the determining the strategy comprises:
determining a set of candidate strategies for the target file folder;
determining a respective cause corresponding to each candidate strategy in the set of candidate strategies; and
determining, as the strategy, a candidate strategy in the set of candidate strategies, which corresponds to the respective cause matching the cause for the target file folder.

6. The method of claim 1, wherein the attribute comprises at least one of:
a first access imbalance by user for the target file folder, the first access imbalance by user indicating a first standard deviation of access rates of the target file folder by a plurality of users accessing the target file folder;
a second access imbalance by time for the target file folder, the second access imbalance by time indicating a second standard deviation of access rates of the target file folder in each of a plurality of time periods; and
a type of the target file folder, the type indicating whether the target file folder is a public target file folder or a private target file folder.

7. The method of claim 1, wherein the cause comprises at least one of:
a normal frequent access;
a greedy user;
an accidental greedy user; or
a time-concentrated frequent access.

8. The method of claim 1, wherein the strategy comprises at least one of:
restricting access to the target file folder by a user;
moving the target file folder from a source storage storing the target file folder to a destination storage, wherein an access speed to the destination storage exceeds a speed threshold; or
providing the cause to the user.

9. A device, comprising:
at least one processing unit;
at least one memory coupled to the at least one processing unit and storing instructions executed by the at least one processing unit, wherein the instructions, when executed by the at least one processing unit, cause the device to perform acts comprising:
determining a target file folder with an access frequency exceeding a frequency threshold in the file system;
determining, based on an attribute of the target file folder, a cause associated with access to the target file folder; and
determining, based on the cause, a strategy associated with the access to the target file folder, to improve access efficiency of the file system.

10. The device of claim 9, wherein the determining the target file folder comprises:
determining, from file folders in the file system, a sub-file folder with access frequency exceeding the frequency threshold; and
determining the sub-file folder as the target file folder.

11. The device of claim 9, wherein the determining the cause comprises:
determining the attribute;
determining an attribute value of the attribute; and
applying the attribute value to a classifier trained to determine the cause.

12. The device of claim 11, wherein the acts further comprise:
obtaining historical attribute values and historical types of the attributes of a plurality of training file folders; and
training the classifier based on the historical attribute values and the historical types.

13. The device of claim 9, wherein determining the strategy comprises:
determining a set of candidate strategies for the target file folder;
determining a respective cause corresponding to each candidate strategy in the set of candidate strategies; and
determining, as the strategy, a candidate strategy in the set of candidate strategies that corresponds to the respective cause matching the cause for the target file folder.

14. The device of claim 9, wherein the attribute comprises at least one of:
a first access imbalance by user for the target file folder, the first access imbalance by user indicating a first standard deviation of access rates of the target file folder by a plurality of users accessing the target file folder;
a second access imbalance by time for the target file folder, the second access imbalance by time indicating a second standard deviation of access rates of the target file folder in each of a plurality of time periods; or
a type of the target file folder, the type indicating whether the target file folder is a public target file folder or a private target file folder.

15. The device of claim 9, wherein the cause comprises at least one of:
a normal frequent access;
a greedy user;
an accidental greedy user; or
a time-concentrated frequent access.

16. The device of claim 9, wherein the strategy comprises at least one of:
restricting access to the target file folder by a user;
moving the target file folder from a source storage storing the target file folder to a destination storage, an access speed to the destination storage exceeding a speed threshold; or
providing the cause to the user.

17. A computer program product tangibly stored on a non-transitory computer-readable medium and including machine-executable instructions, the machine-executable instructions, when executed, causing a machine to perform operations, comprising:
determining a target file folder with an access frequency exceeding a frequency threshold in a file system;
based on an attribute of the target file folder, determining a cause associated with access to the target file folder; and
based on the cause, determining a strategy associated with the access to the target file folder, to improve access efficiency of the file system.

18. The computer program product of claim 17, wherein the operations further comprise:
obtaining historical attribute values and historical types of the attributes of a plurality of training file folders;
training a classifier based on the historical attribute values and the historical types, resulting in a trained classifier;
determining the attribute;
determining an attribute value of the attribute; and
applying the attribute value to the trained classifier to determine the cause.

19. The computer program product of claim 17, wherein the determining the strategy comprises:
determining candidate strategies for the target file folder;
determining respective causes corresponding to the candidate strategies; and
determining, as the strategy, a candidate strategy of the candidate strategies, which corresponds to a respective cause of the respective causes matching the cause for the target file folder.

20. The computer program product of claim 17, wherein the attribute comprises at least one of:
a first access imbalance by user for the target file folder, the first access imbalance by user indicating a first standard deviation of access rates of the target file folder by users accessing the target file folder;
a second access imbalance by time for the target file folder, the second access imbalance by time indicating a second standard deviation of access rates of the target file folder in each time period of time periods; and
a type of the target file folder, the type indicating whether the target file folder is a public target file folder or a private target file folder, and
wherein the cause comprises at least one of:
a normal frequent access;
a greedy user;
an accidental greedy user; or
a time-concentrated frequent access.
